(19) United States
(12) Patent Application Publication
(10) Pub. No.: US 2019/0267844 A1
(43) Pub. Date: Aug. 29, 2019

(54) SYSTEM AND PROCESS FOR TRANSMITTING ELECTRICITY POWER

(71) Applicant: POWERSOFT S.P.A., Scandicci Italy (IT)

(72) Inventor: Claudio Lastrucci, Scandicci Italy (IT)

(73) Assignee: POWERSOFT S.P.A., Scandicci Italy (IT)

(21) Appl. No.: 16/284,274

(22) Filed: Feb. 25, 2019

(30) Foreign Application Priority Data
Feb. 23, 2018 (IT) 102018000002986

(51) Int. Cl. H02J 50/12; H02J 5/00; H02J 7/02

(52) U.S. Cl. CPC H02J 50/12; H02J 7/025; H02J 5/005

(57) ABSTRACT

Described is a system (1) for transmitting electrical power comprising a sinusoidal alternating current generator (2) which can be connected to a power supply source and operating at a non-resonant fixed frequency, a transmission circuit (3), of the non-resonant type, connected with the current generator (2) using a closed path and configured to generate a magnetic field and at least one receiver circuit (4), of the resonant type, which can be connected to a user (U) and which can be positioned in a space close to the transmission circuit to be immersed in the magnetic field generated by the transmission circuit (3) in such a way as to generate an induced current for powering the user (U). The receiver circuit (4) is designed to maintain a tuning between the fixed frequency of the current generator (2) and a resonance frequency of the circuit receiver (4).

### CROSS REFERENCE TO RELATED APPLICATIONS

This application relates to, and claims priority from, IT 102018000002986 filed on Feb. 23, 2018, the entire contents of which are incorporated herein by reference.

### FIGURE SELECTED FOR PUBLICATION

FIG. 1

### BACKGROUND OF THE INVENTION

### Field of the Invention

This invention relates to a system for transmitting electrical power.

### Description of the Related Art

During everyday life use is made of electronic appliances of many types and for a wide range of purposes. Personal computers, videogame consoles, televisions, lamps, household appliances and the like are only some of the apparatuses used every day. In general, reference will be made to these apparatuses with the term “users”.

A first problem arises from the need to have several users connected to a domestic mains supply whilst at the same time having a low number of sockets in a room where the above-mentioned apparatuses are to be connected.

Another problem arises from the power cables of the above-mentioned users which, even if grouped together in single blocks, can cause different overall dimensions. For example, a user might trip over the above-mentioned cables or, if one of the above mentioned apparatuses is to be moved, the cables may become twisted with each other, resulting in a loss of time for the user.

Systems and apparatuses are also known for the wireless transmission of energy, but, disadvantageously, they are not able to transmit sufficient levels of energy. For example, the distance between the transmitter and receiver apparatuses is a first cause for a non-optimum energy transmission.

More specifically, these systems/apparatuses use variable capacitors in order to guarantee a certain level of energy transmitted but they are not, however, able to reach satisfactory performance levels for the purpose of correct operation of the users powered by the system/apparatus.

Even more specifically, as a result of the variations in constructional tolerances or the introduction of metal objects inside the system/apparatus the tuning in the transmission of the energy may not be optimum and the variable capacitors are not sufficiently suitable to compensate for these variations, therefore resulting in phase displacement of the system/apparatus.

### ASPECTS AND SUMMARY OF THE INVENTION

The technical purpose of the invention is therefore to provide a system for transmitting electrical power and a process for transmitting electrical power which are able to overcome the drawbacks of the prior art.

More specifically, an aim of the invention is to provide a system for transmitting electrical power and a process for transmitting electrical power which allow the use of a large number of users even in the presence of a low number of electrical sockets.

A further aim of the invention is to provide a system for transmitting electrical power and a process for transmitting electrical power which allow a more efficient transmission of the energy relative to the prior art systems and apparatuses.

The technical purpose indicated and the aims specified are substantially achieved by a system for transmitting electrical power and a process for transmitting electrical power comprising the features described in one or more of the appended claims. The dependent claims can correspond to possible embodiments of the invention.

Further features and advantages of the invention are described in more detail below, with reference to a preferred, non-limiting embodiment of a system for transmitting electrical power and an apparatus for transmitting electrical power with reference to the accompanying drawing.

The above and other aspects, features and advantages of the present invention will become apparent from the following description read in conjunction with the accompanying drawings, in which like reference numerals designate the same elements.

### BRIEF DESCRIPTION OF THE DRAWINGS

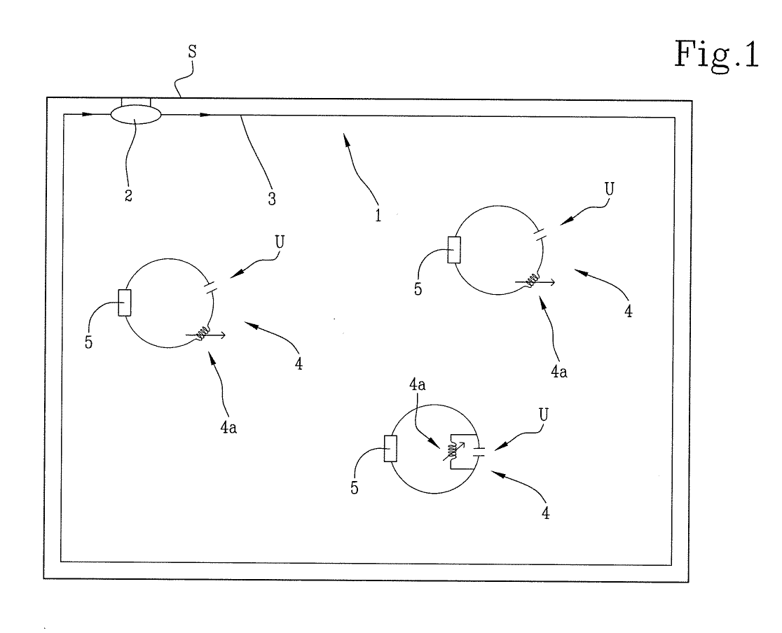

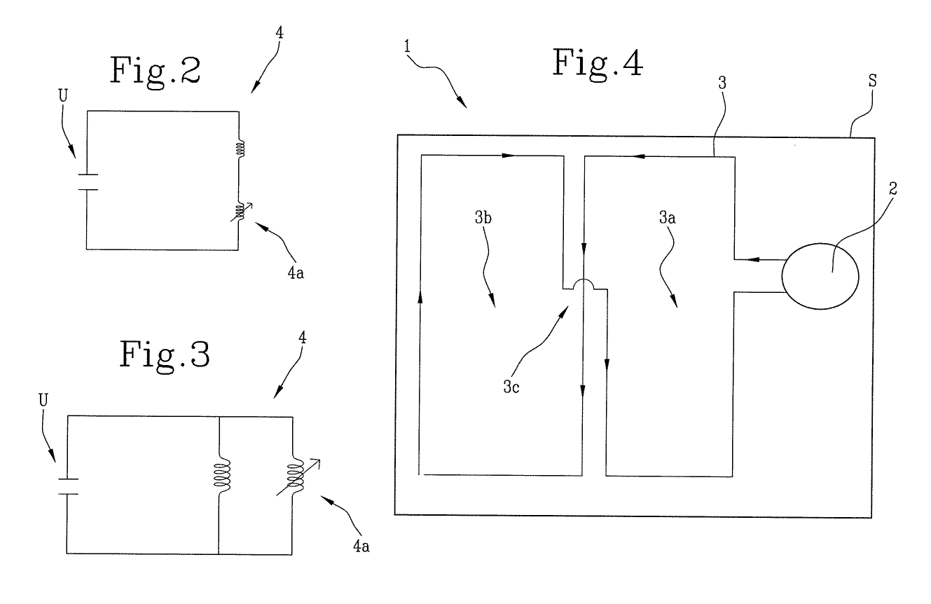

FIG. 1 is a schematic view of a system for transmitting electrical power according to the invention.

FIG. 2 is a schematic view of a component of the transmission system of FIG. 1 according to a first embodiment.

FIG. 3 is a schematic view of the component of FIG. 2 according to a second embodiment.

FIG. 4 is a schematic view of a further component of the system for transmitting electrical power according to a relative alternative embodiment.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

With reference to the accompanying drawings, the numeral 1 denotes in its entirety a system for transmitting electrical power which, for simplicity of description, will hereafter be referred to as system 1.

The system 1 comprises a high-frequency current generator 2 operating at a fixed frequency.

The current generator 2 is connectable to a domestic mains supply in such a way as to generate a current to be introduced into the system 1.

Preferably, the current generator 2 operates at a fixed frequency which may be selected between a range of between 25 hertz and 5 megahertz.

The choice of frequency at which the current generator 2 operates is predetermined on the basis of the users to be powered with the system 1 or the domestic mains supply to which the current generator 2 is connected.

More specifically, the current generator 2 is a sinusoidal alternating current generator.

The system 1 also comprises a non-resonant transmission circuit 3. The choice of a non-resonant circuit is preferable to other solutions since it facilitates the installation of the system 1 inside the room. More specifically, a non-resonant circuit does not require tuning adjustments during installation.

More specifically, the transmission circuit 3 is connected with the current generator 2 by means of a closed path and is configured to generate a magnetic field. In other words, the current input and output of the transmission circuit 3 coincide with the current generator 2.

More specifically, the transmission circuit 3 is passed through by the current generated by the current generator 2 generating the above-mentioned magnetic field. More specifically, the magnetic field is generated inside and outside the perimeter delimited by the closed path of the transmission circuit 3.

The fixed frequency of the current generator 2 coincides with a non-resonant frequency of the transmission circuit 3

As mentioned above, the choice of the fixed frequency depends on the characteristics of the domestic mains supply and/or the receivers to be powered and/or the transmission circuit 3. Preferably, the choice of the fixed frequency depends on standards which limit the intensity of the magnetic field in relation to the human body.

The system 1 also comprises at least one resonant type receiver circuit 4. The receiver circuit 4 is connected to a user and can be positioned in an area close to the transmission circuit 3 in such a way that a current is induced to be sent to the user.

In other words, the receiver circuit 4 is located inside or outside the perimeter of the transmission circuit 3 in such a way as to be struck by the magnetic field for inducing the current.

The term “user” is used to mean any type of electrical or electronic device or device which, in any case, requires an electricity supply for it to be powered and therefore perform its function.

These users can be, for example, lamps, electric household appliances or personal computers, multimedia devices or devices for audio reproduction.

In general, the term “user” is used to mean any apparatus which would require connection to the domestic mains supply or which would require batteries in order to operate.

FIG. 1 shows a system in which there are three users ‘U’ with the respective receiver circuits 4.

Each receiver circuit 4 is designed to maintain a tuning between the fixed frequency of the current generator 2 and a resonance frequency of the circuit receiver 4. More specifically, the tuning must be maintained in order to maximize the transmission of energy between the transmission circuit 3 and the receiver circuit 4.

Preferably, the receiver circuit 4 is configured to generate a control current in such a way as to keep fixed the tuning between the fixed frequency of the current generator 2 and the resonance frequency of the receiver circuit 4.

The circuit receiver 4 preferably comprises an energy storage system 5 which makes it possible to use the user even when the system 1 is not in operation for any reason. For example, the energy storage system 5 may be made in the form of an energy storage battery.

The energy storage system 5 may be recharged by inducing current obtained with the transmission circuit 3. In other words, the transmission circuit 3 makes it possible to transmit power to the users and to recharge the energy storage system 5.

Preferably, the energy storage batteries make it possible to generate the control current which makes it possible to maintain the receiver circuit 4 (more specifically, its resonance frequency) in tune with the transmission circuit 3 (that is, at the fixed frequency of the current generator 2).

The receiver circuit 4 might not have an energy storage system 5 but receive the control current directly from the system 1. In this way, if the system 1 is switched off, the receiver circuit 4 would not operate but the presence of single storage systems onboard the user ‘U’ is avoided.

Preferably, the receiver circuit 4 (or the receiver circuits 4 as shown in the accompanying drawings) is made by means of a variable linear inductor 4a configured to tune the receiver circuit 4 to the fixed frequency of the current generator 2. In other words, the receiver circuit 4 comprises a variable linear inductor 4a for tuning the receiver circuit 4 (resonant) to the non-resonant fixed frequency of the current generator 2.

In other words, as per the design of the system, the frequencies of the receiver circuits 4 are tuned with the fixed frequency of the current generator 2.

Following possible interferences or variations in construction tolerances it is necessary that the tuning is maintained in order to prevent a deviation between the frequencies (also called mistuning) and, therefore, a non-optimum energy transmission.

The control current thus makes it possible to vary the inductance of the receiver circuit 4 (more specifically, the inductance of the variable linear inductor 4a with which the receiver circuit 4 is made) in such a way as to compensate for the variation or interference which would result in a mistuning between the frequencies.

As shown in FIG. 2, the variable linear inductor 4a can be made as an inductance in series to the user ‘U’ (that is, to the inductance of the circuit of the user ‘U’). In this way, the variable linear inductor 4a generates a control inductance which corresponds to an inductance delta subtracted from the inductance of the user ‘U’.

As shown in FIG. 3, the variable linear inductor can be made as an inductance in parallel to the user ‘U’ (that is, to the inductance of the circuit of the user ‘U’). In this way, the variable inductor 4a generates a control inductance which corresponds to an inductance delta which is added to the inductance of the user ‘U’.

FIG. 1 shows two users ‘U’ in which the variable linear inductor 4a is made as an inductor in series and a user ‘U’ in which the variable linear inductor 4a is in parallel.

The system 1 is able to detect the mistuning using suitable algorithms implemented in the receiver circuit 4 which therefore activate the receiver circuit 4 so that it intervenes to return the required tuning between the frequencies so as to maximize energy transfer.

Merely by way of example, and therefore non-limiting, an algorithm for identifying the maximum transfer point may be the MPPT (Maximum Power Point Tracker) algorithm.

The system 1 described above and in particular the transmission circuit 3 is connected, for example, at a perimeter of a room ‘S’ in such a way as to generate the magnetic field so as to induce a current in the at least one receiver circuit 4 when located in the proximity of the perimeter.

In other words, the current generator 2 is connected to the domestic mains supply by means of a power socket and the transmission circuit 3 is installed on the walls or portions of walls or on the floor of the room in such a way as to form the closed path with which it is connected to the current generator 2. The transmission circuit 3 may be installed inside or outside the walls of the room ‘S’, provided the installation allows the transmission of the electricity to the users ‘U’.

In this way, when the receiver circuit 4 installed on the user ‘U’ is located inside the room ‘S’ (that is, close to the transmission circuit 3) the current is induced in the receiver circuit 4 thus activating the user ‘U’.

Preferably, the at least one receiver circuit 4 (that is, the user ‘U’) is equipped with a switch for switching on so as to induce, or not, the current when the receiver circuit 4 is positioned inside the perimeter of the room ‘S’. In other words, if it is not necessary for the user ‘U’ to be activated although positioned in the room, the circuit receiver 4 may be switched off by the above-mentioned switch, allowing a further control on the user ‘U’.

Preferably, the transmission circuit 3 is equipped with a relative switch for switching on in such a way as to generate, or not, the magnetic field on the basis of the requirements of a user who enters the room.

Preferably, the at least one receiver circuit 4 is provided with an energy storage battery 5, as described above, which can be operated by means of the above-mentioned ON switch in such a way that user can be switched on even when the transmission circuit 3 is switched off.

In other words, a user is able to charge the energy storage battery 5 by switching on the transmission circuit 3 and, once the transmission circuit 3 is switched off, switching on the circuit receiver 4 of the user ‘U’ when necessary without necessarily using the transmission circuit 3.

FIG. 4 shows an alternative embodiment of the transmission circuit 3 described above.

Preferably, therefore not necessarily, the alternative embodiment could be installed in the floor or ceiling of the room ‘S’.

More specifically, the transmission circuit 3 is divided into a first portion 3a and a second portion 3b formed by a single circuit wherein the transmission circuit 3 is bent on itself forming a point of substantial superposing 3c.

At this superposing point 3c (as well as along the entire portion in which the transmission circuit 3 is parallel to itself), preferably central to the room ‘S’, there is a double intensity of the magnetic field.

In this way, with the same power of the system 1 described above, there is an increase in the transmission of electricity four times greater than the previous case.

The invention further relates to a process for transmitting electrical power.

The process comprises preparing a system 1 such as that described above. More specifically, the process comprises preparing the transmission circuit 3 of the system 1 close to a perimeter of a room ‘S’ (for example, in the walls or in the floor of the room ‘S’) as shown in the accompanying drawings. In this way, the transmission circuit 3 defines a transmission space in the vicinity of the transmission circuit 3.

The process comprises connecting the high-frequency current generator 2 the domestic mains supply or to any electricity supply source. Connecting the current generator 2 to the domestic mains supply (or another source of energy supply) allows a current to pass through the transmission circuit 3 in such a way as to generate a magnetic field in the proximity of the transmission space. In other words, following the connection of the current generator 2 (non-resonant operating at a fixed frequency) to the domestic mains supply, the magnetic field is generated in the transmission space.

At this point, a receiver circuit 4 (connected to a user ‘U’) is immersed in the inside area in such a way that it is struck by the magnetic field in such a way as to generate an induced current in the receiver circuit 4.

The current induced thus makes it possible to power the user ‘U’ connected to the receiver circuit 4.

The system 1 and the process described above overcome the drawbacks of the prior art.

More specifically, the system 1 and the process described above allow the transfer of energy with a greater efficiency relative to the prior art systems and apparatuses.

Advantageously, the system 1 and the process described above allow a use of a greater number of users whilst maintaining the tuning between the transmission circuit 3 and the at least one receiver circuit 4.

Advantageously, the system 1 and the process described above are able to better compensate for variations of constructional tolerances or the introduction of interference with respect to the prior art systems and apparatuses.

Various operations may be described as multiple discrete operations in turn, in a manner that may be helpful in understanding embodiments of the present invention; however, the order of description should not be construed to imply that these operations are order dependent.

It will be further understood by those of skill in the art that the apparatus and devices and the system and process herein, without limitation, and includes the sub components such as operational structures, circuits, communication pathways, and related elements, control elements of all kinds, display circuits and display systems and elements, any necessary driving elements, inputs, sensors, links, connectors, detectors, memory elements, processors and any combinations of these structures etc. as will be understood by those of skill in the art as also being identified as or capable of operating the systems and devices and subcomponents noted herein and structures that accomplish the functions without restrictive language or label requirements since those of skill in the art are well versed in related systems and processes for transmitting electricity power, and operational controls and technologies of power transmitting systems and all their sub components, including various links, capacitors, resistors, and other combinations of circuits without departing from the scope and spirit of the present invention.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A system (1) for transmitting electrical power comprising:
a sinusoidal alternating current generator (2) which can be connected to a power supply source and operating at non-resonant fixed frequency;
a transmission circuit (3), of the non-resonant type, connected with the current generator (2) using a closed path and configured to generate a magnetic field; and
at least one receiver circuit (4), of the resonant type, which can be connected to a user (U) and which can be positioned in a space close to the transmission circuit to be immersed in the magnetic field generated by the transmission circuit (3) in such a way as to generate an induced current for powering the user (U), the receiver circuit (4) being designed to maintain a tuning between the fixed frequency of the current generator (2) and a resonance frequency of the circuit receiver (4).

2. The system (1) for transmitting electrical power according to claim 1, wherein:
the at least one receiver circuit (4) is made with a variable linear inductor (4a) configured for tuning the resonance frequency of the receiver circuit (4) to the non-resonant fixed frequency of the current generator (2).

3. The system (1) for transmitting electrical power according to claim 1, wherein:
the at least one receiver circuit (4) is equipped with an energy storage system (5).

4. The system (1) for transmitting electrical power according to claim 1, wherein:
the at least one receiver circuit (4) is configured for generating a control current in such a way as to maintain a tuning between fixed frequency and the frequency of the receiver circuit (4).

5. The system (1) for transmitting electrical power according to claim 1, wherein:
the fixed frequency can be selected from a range of between 25 hertz and 5 megahertz.

6. The system (1) for transmitting electrical power according to claim 1, wherein:
the at least one receiver circuit (4) is equipped with a switch for switching ON in such a way as to induce or not the current when the latter is positioned inside the perimeter.

7. A system (1) for transmission of electrical power according to claim 1, wherein:
the transmission circuit (3) is equipped with a relative switch for switching ON in such a way as to generate or not the magnetic field.

8. The system (1) for transmitting electrical power according to claim 6, wherein:
the at least one receiver circuit (4) is equipped with an energy storage system (5) which can be operated by means of the switch for switching ON or not of the user (U) when the transmission circuit (3) is switched OFF.

9. A process for the transmission of electrical power comprising the steps of:
preparing a system (1) according to claim 1;
preparing a transmission circuit (3) along a perimeter of a room (S) in such a way as to define a transmission space in the vicinity of the transmission circuit (3);
connecting a current generator (2) with high frequency and operating at fixed frequency to a domestic network;
generating a magnetic field in the inner area through the transmission circuit (3) following the connection of the current generator (2) to the domestic network;
immersing at least one receiver circuit (4) in the inner area in such a way that it is struck by the magnetic field in such a way as to generate an induced current; and
powering a user (U) connected to the receiver circuit (4) with the induced current.
